(19) United States
(12) Patent Application Publication
(10) Pub. No.: US 2016/0165690 A1
(43) Pub. Date: Jun. 9, 2016

(54) CUSTOMIZED AUDIO DISPLAY SYSTEM

(71) Applicant: STAGES PCS, LLC, Princeton, NJ (US)

(72) Inventor: Benjamin D. Benattar, Cranbury, NJ (US)

(73) Assignee: STAGES PCS, LLC, Ewing, NJ (US)

(21) Appl. No.: 14/960,189

(22) Filed: Dec. 4, 2015

Related U.S. Application Data
(63) Continuation-in-part of application No. 14/561,972, filed on Dec. 5, 2014.
Application No. 14/561,972 is a continuation-in-part of application No. 14/827,315, filed on Aug. 15, 2015.
Application No. 14/827,315 is a continuation-in-part of application No. 14/827,316, filed on Aug. 15, 2015.
Application No. 14/827,316 is a continuation-in-part of application No. 14/827,317, filed on Aug. 15, 2015.
Application No. 14/827,317 is a continuation-in-part of application No. 14/827,319, filed on Aug. 15, 2015.
Application No. 14/827,319 is a continuation-in-part of application No. 14/827,320, filed on Aug. 15, 2015.
Application No. 14/827,320 is a continuation-in-part of application No. 14/827,322, filed on Aug. 15, 2015.

(51) Int. Cl. H05B 33/08; G09G 5/30; G09G 5/02; G09G 5/10; H05B 37/02; F21V 33/00

(52) U.S. Cl. CPC H05B 33/0842; H05B 37/0227; F21V 33/0056; G09G 5/02; G09G 5/10; G09G 5/30; G09G 2320/0653

(57) ABSTRACT

A lighting display system is coordinated with an operating parameter of a personalized audio play device. An object is to provide some display components representative of audio output or another operating parameter of a customized audio device. The system may operate in an environment where a customized audio device is provided which facilitates a user listening to ambient sounds through a personal speaker system where a customized audio device enhances the listening experience by modifying ambient audio and/or delivery of supplemental audio to the personal speakers. Once personalized listening devices are used in a live entertainment setting such as a festival, concert, or arena, LEDs or other color or pattern-coded lights or images may be embedded in personal speakers such as headphones or earphone devices. For example the lighting display may be part of a headphone top band, side cups, or a neck holder for earphones. The lighting display is manipulated by various controls setting off/on, colors, and/or images based on sounds heard by the device, the user, or based on ultrasonic, or RF communications received by the device or controlling connected devices

### CROSS REFERENCE TO RELATED APPLICATIONS

This application is a continuation-in-part of and claims priority and the benefit of the filing dates of co-pending U.S. patent application Ser. No. 14/561,972 filed Dec. 5, 2014, U.S. Pat. No. ______ and its continuation-in-part applications U.S. patent application Ser. No. 14/827,315 (Attorney Docket Number 111003); Ser. No. 14/827,316 (Attorney Docket Number 111004); Ser. No. 14/827,317 (Attorney Docket Number 111007); Ser. No. 14/827,319 (Attorney Docket Number 111008); Ser. No. 14/827,320 (Attorney Docket Number 111009); Ser. No. 14/827,322 (Attorney Docket Number 111010), filed on Aug. 15, 2015, all of which are hereby incorporated by reference as if fully set forth herein. This application is related to U.S. patent application Ser. No. ______ (Attorney Docket Number 111012); U.S. patent application Ser. No. ______ (Attorney Docket Number 111013); U.S. patent application Ser. No. ______ (Attorney Docket Number 111014); U.S. patent application Ser. No. ______ (Attorney Docket Number 111016); U.S. patent application Ser. No. ______ (Attorney Docket Number 111017); U.S. patent application Ser. No. ______ (Attorney Docket Number 111018); ______; U.S. patent application Ser. No. ______ (Attorney Docket Number 111019); and U.S. patent application Ser. No. ______ (Attorney Docket Number 111020), all filed on even date herewith, all of which are hereby incorporated by reference as if fully set forth herein.

### BACKGROUND OF THE INVENTION

1. Field of the Invention

The invention relates to lighting devices, and more particularly to lighting devices with a display related to audio content at a customized audio play system.

2. Description of the Related Technology

U.S. Pat. No. 3,806,919 entitled, “Light Organ,” is expressly incorporated by reference herein. U.S. Pat. No. 3,806,919 relates to a light organ and shows a system for energizing lights in response to sound intensity. Light organs may be responsive to a microphone or electrical signals corresponding to audio. U.S. Pat. No. 3,806,919 shows a detector amplifier stage that generates a signal representative of sound intensity detected by a microphone. The output of the amplifier stage controls the switching of a phase-controlled power switch connected across one of two lamp filaments connected in series. As the intensity of one lamp increases with sound intensity, the intensity of the other decreases. Automatic gain control circuitry adjusts the gain of the amplifier stages such that the lighting effect is substantially the same response for sound changes, and it is independent of ambient sound level. The lamps used are disclosed as having filaments which operate across an AC power source such as a full wave rectified 117-volt, 60 Hertz source.

In various lighting applications, the use of light emitting diodes (LEDs) for illumination or decoration is now known. LEDs have long life, are energy efficient, are durable and operate over a wide temperature range. PixMob offers a wireless lighting technology that controls wearable LED devices intended to be worn by many individuals in a densely populated area such as a stadium or arena. By transforming the wearable objects into pixels, the crowd becomes a display. The light effects produced by the LED devices can be controlled to match a light show, pulsate in sync with the music, react to the body movement, etc. PixMob technology uses infrared or Bluetooth Low Energy (“BLE”) to control RGB LEDs that are embedded in different objects such as balls or wristbands. These wearable objects are given to an audience, transforming each individual into a pixel during the show. To light up each pixel (i.e. each LED), commands are sent from computers to transmitters that emit invisible light (infrared) or BLE. The signals are picked up by receivers in each object and goes to a microprocessor to control the LEDs. This enables the creation of animated video effects and transforms the audience into a display screen. Despite the low-resolution result due to a low number of pixels, quite detailed video effects can be achieved on a large canvas, using bright colors and bold movements. The control of an individual LED may be either based on an expected location of the LED or may be dependent on proximity to a known location.

Xylobands are another known wearable LED and control system for use, for example, in a concert venue. Xylobands are wristbands which contain light-emitting diodes and radio frequency receivers. The lights inside the wristband may be controlled by a software program, which sends signals to the wristband, instructing it to light up or blink, for example. They are available in green, blue, yellow, red, pink and white. The wristbands themselves may be constructed of a thick fabric with LEDs inside the fabric. A radio receiver is located within a plastic piece on the band, and it receives wireless signals from a controller, which is hosted on a laptop computer linked to a radio transmitter, which can remotely control the bands from up to 328 yards away. The operator of the laptop software may program all wristbands or only those of certain colors to flash on and off at specific intervals and specific moments. The wristbands are not intended to be lit outside of the concert venue. https://en.wikipedia.org/wiki/Xyloband.

U.S. 2014/0184386 A1 relates, in general, to an interactive lighting effect and is particularly, but not exclusively, applicable to electronic wristbands that can be selectively activated to energize light emitting devices integrated into each wristband to produce a coordinated display from individual wristbands worn by members of an audience at a show, such as a concert or a sporting event. In the exemplary context of an RF-based LED wristband with an integrated antenna. The wristbands are intended to be distributed at an event upon payment to an event organizer or pre-delivered. Typically, the wristband will include a controller coupled to a local power source, such as a battery. The controller is programmable through a suitable interface, which may include a physical connection or a passively accessible contact. In addition, each wristband contains at least one high-intensity LED device (or other controllable light-emitting device) operationally responsive to a control signal issued by a control station. The control station communicates with the wristbands using an RF transmitter and, if necessary, repeater stations that provide appropriate RF coverage within an arena or venue. Data bursts may be targeted using an activation code assigned to one or more of the wristbands. The wristbands may be assigned a zone address correspondingly the section of the venue that the user is expected to be in before it is deployed. Actuation of LEDs on the wristbands to support lighting effects is based on the assigned address and is not dependent on the actual location of the wristband in any way. The use of RF is preferred.

WO 2014/096861 A2 relates to a system for controlling light devices in a venue to create an image based on the position of the light devices. The position of a light device may be determined by GPS data or proximity using near field technology, RFID tags, or Bluetooth Low Energy devices such as i Beacons (RTE). Data indicative of the position of the pixel device is received at a server, a display attribute is calculated based on the position. This is particularly useful where the pixel devices are devices without a fixed position, such as mobile phones, PDAs and tablets, etc. for forming complex visual effects.

### SUMMARY OF THE INVENTION

A lighting display system which is coordinated with an operating parameter of a personalized audio play device. An object is to provide some display components representative of audio output or another operating parameter of a customized audio device. The system operates in an environment where a customized audio device is provided which facilitates a user listening to ambient sounds through a personal speaker system where a customized audio device enhances the listening experience by modifying ambient audio and/or delivery of supplemental audio to a user. Once personalized listening devices are used in a live entertainment setting such as a festival, concert, or arena, LEDs or other color or pattern-coded lights or images may be embedded in headphones or earphone devices. For example the lighting display may be part of a headphone top band, side cups, or a neck holder for earphones. The lighting display is manipulated by various controls setting off/on, colors, and/or images based on sounds heard by the device, the user, or based on ultrasonic, or RF communications received by the device or controlling connected devices.

The lighting display features may be used with a personalized audio delivery system to reflect some aspect of the audio being played. This may be desirable in the context of a shared music experience or other environments. The description is given in the context of a shared music experience, but the lighting system is not limited to such use. A shared music experience can be specific to an individual group member but still share a common group music characteristic.

The system may be useful to provide a personal audio delivery system at a festival concert where a user wearing headphones can hear any source, stage, show, and designated information, directions, promotion, and other content anywhere. Content may be delivered over small-cell LTE stepped up or by another distribution methodology such as Wi-Fi, P2P, BLE, or cellular. The personal audio delivery system may be controlled using an app running on a personal communication device. Transmission media may be small-cell LTE stepped up and controlled by a mobile user interface on the personal communication device. In addition, the personal audio delivery system may facilitate coordinated group social discussion, speech and shared content experience (nightclub or festival or any environment such as a conference, convention, schoolyard, etc.). Speakers with accepted profiles may be included in a group audio chat utilizing a customized audio delivery system integrated with the personal audio delivery system.

The personal audio delivery system may be a networking content delivery system which includes a plurality of user profiles, each corresponding to a user ID. A connection table controlling the connections containing a plurality of authorization identifications may be provided with a connection authorization where the connection authorizations include one or more user IDs and corresponding content identifications. Matching logic responsive to user profiles and the connection table may be provided for establishing connections to one or more communication devices corresponding to one or more of the user IDS. The networking content delivery system may be controlled or coordinated through a connection server. The content identification may represent identification of stored content or streaming content. The streaming content may be live. The stored content may be live or messaging content. The content identification may identify a communications channel or an audio profile. The audio profile may be a directional or geographic profile or may be a profile characterizing audio information.

The system may generate notifications delivered to the personal communication devices identifying available content. The personal communication devices may include an interface to designate content that will be processed by the personal communication device. The system may include matching logic which represents a set of matching criteria that correlate one or more user IDs. The lighting displays may be set or coordinated with the selected content.

The system may implement a method of coordinating the delivery of audio and lighting display content to a personal communication device which includes the steps of designating a principle content stream at the personal communication device, designating one or more supplemental context streams, and customizing content output of a personal communication device where the content output includes a principal audio content stream and at least one supplemental content stream. The display system may involve designating one or more attributes of the content output or personal information correlated to a personal communication device, transforming the designated attribute or attributes to a lighting effect and using the lighting effect to drive a light display.

A personal lighting display system may be used in conjunction with the personalized audio play device or a customized audio device. A display attribute generation unit may be connected to the personalized or customized audio play device. The display attribute generation unit may be integrated together with the audio device. A display driver may be responsive to the display attribute generation unit and generate signals to drive a lighting device connected to the display driver. The lighting display device may be monochrome, multicolor, LED, or multi-pixel. The display device may be configured for public rather than personal display. The display attribute generation unit may be responsive to an operating parameter of the personalized or customized audio play device. The operating parameter may be an identification of content, may be some aspect of a user profile, or may be simply set by a user for the purpose of display. The operating parameter may be a combination of elements.

It is an object to work with an audio customization system to enhance a user's audio environment. One type of enhancement would allow a user to wear headphones and specify what ambient audio and source audio will be transmitted to the headphones. Added enhancements may include the display of an image representing the location of one or more audio sources referenced to a user, an audio source, or other location and/or the ability to select one or more of the sources and to record audio in the direction of the selected source(s). The system may take advantage of an ability to identify the location of an acoustic source or a directionally discriminating acoustic sensor, track an acoustic source, isolate acoustic signals based on location, source and/or nature of the acoustic signal, and identify an acoustic source. In addition, ultrasound may be serve as an acoustic source and communication medium.

In order to provide an enhanced audio experience to the users a source location identification unit may use beamforming in cooperation with a directionally discriminating acoustic sensor to identify the location of an audio source. The location of a source may be accomplished in a wide-scanning mode to identify the vicinity or general direction of an audio source with respect to a directionally discriminating acoustic sensor and/or in a narrow scanning mode to pinpoint an acoustic source. A source location unit may cooperate with a location table that stores a wide location of an identified source and a “pinpoint” location. Because narrow location is computationally intensive, the scope of a narrow location scan can be limited to the vicinity of sources identified in a wide location scan. The source location unit may perform the wide source location scan and the narrow source location scan on different schedules. The narrow source location scan may be performed on a more frequent schedule so that audio emanating from pinpoint locations may be processed for further use.

The location table may be updated in order to reduce the processing required to accomplish the pinpoint scans. The location table may be adjusted by adding a location compensation dependent on changes in position and orientation of the directionally discriminating acoustic sensor. In order to adjust the locations for changes in position and orientation of the sensor array, a motion sensor, for example, an accelerometer, gyroscope, and/or manometer, may be rigidly linked to the directionally discriminating sensor, which may be implemented as a microphone array. Detected motion of the sensor may be used for motion compensation. In this way the narrow source location can update the relative location of sources based on motion of the sensor arrays. The location table may also be updated on the basis of trajectory. If over time an audio source presents from different locations based on motion of the audio source, the differences may be utilized to predict additional motion and the location table can be updated on the basis of predicted source location movement. The location table may track one or more audio sources.

The locations stored in the location table may be utilized by a beam-steering unit to focus the sensor array on the locations and to capture isolated audio from the specified location. The location table may be utilized to control the schedule of the beam steering unit on the basis of analysis of the audio from each of the tracked sources.

Audio obtained from each tracked source may undergo an identification process. An identification process is described in more detail in U.S. patent application Ser. No. 14/827,320 filed Aug. 15, 2015, the disclosure of which is incorporated herein by reference. The audio may be processed through a multi-channel and/or multi-domain process in order to characterize the audio and a rule set may be applied to the characteristics in order to ascertain treatment of audio from the particular source. Multi-channel and multi-domain processing can be computationally intensive. The result of the multi-channel/multi-domain processing that most closely fits a rule will indicate the processing. If the rule indicates that the source is of interest, the pinpoint location table may be updated and the scanning schedule may be set. Certain audio may justify higher frequency scanning and capture than other audio. For example speech or music of interest may be sampled at a higher frequency than an alarm or a siren of interest.

Computational resources may be conserved in some situations. Some audio information may be more easily characterized and identified than other audio information. For example, the aforementioned siren may be relatively uniform and easy to identify. A gross characterization process may be utilized in order to identify audio sources which do not require computationally intense processing of the multi-channel/multi-domain processing unit. If a gross characterization is performed a ruleset may be applied to the gross characterization in order to indicate whether audio from the source should be ignored, should be isolated based on the gross characterization alone, or should be subjected to the multi-channel/multi-domain computationally intense processing. The location table may be updated on the basis of the result of the gross characterization.

In this way the computationally intensive functions may be driven by a location table and the location table settings may operate to conserve computational resources required. The wide area source location may be used to add sources to the source location table at a relatively lower frequency than needed for user consumption of the audio. Successive processing iterations may update the location table to reduce the number of sources being tracked with a pinpoint scan, to predict the location of the sources to be tracked with a pinpoint scan to reduce the number of locations that are isolated by the beam-steering unit and reduce the processing required for the multi-channel/multi-domain analysis.

Various objects, features, aspects, and advantages of the present invention will become more apparent from the following detailed description of preferred embodiments of the invention, along with the accompanying drawings in which like numerals represent like components.

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

The invention and the following detailed description of certain embodiments thereof may be understood by reference to the following figures:

FIG. 1 shows a representative shared music session.

FIG. 2 shows an embodiment of a PCD during a shared music session.

FIG. 3 shows a content selection system.

FIG. 4 shows an embodiment of a personalized lighting display system.

### DETAILED DESCRIPTION OF THE PREFERRED EMBODIMENT

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

The system may be used, for example, amongst a group of people each using a personal communication device linked to a customized audio delivery system in a multifaceted event. In an exemplary environment they may be participating in an event that may be spread across a large geographic area. In other cases participants may be densely assembled. Examples of multifaceted events include, but are not limited to arena venues, festival events, fairs, and conventions/exhibitions. Information may be passed between personal communication devices of the participants using point-to-point wireless communication, a distributed network of computers such as the Internet, a wireless communication network, small cell LTE, Wi-Fi, and so on. In any case, information received at the personal communications devices can include an identification of the event and an indication of available content or identification of one or more other participants possibly according to some specified criteria that can be passed to a participant's personal communication device.

The system can be implemented as part of a communication system for establishing and providing preferred audio, as described in U.S. patent application Ser. No. 14/827,315, filed Aug. 15, 2015, the disclosure of which is expressly incorporated herein; and/or a mutual permission customized audio source connection system as described in U.S. patent application Ser. No. 14/827,316, filed Aug. 15, 2015, the disclosure of which is expressly incorporated herein.

In the described embodiments, the personal communication device can take the form of a portable media player, cellular phone, or as a handheld computing device such as a tablet computer. In any case, the personal communication device can be configured to wirelessly receive and in some cases may send a signal that can contain information that can include a menu of available content, requests for content and/or communication with or to facilitate communications with other participants and/or event updates or news flashes (announcements). The information can include a snippet or chunk of data that can be broadcasted by one or more devices to other devices that are within the transmission range of the broadcasting device(s). In one embodiment, the snippet or chunk of data can take the form of a token that can be used to seed a group of personal communication devices with the menu of available content. The token can be stored in a personal communication device and concurrently broadcasted to any other personal communication device using, for example, short message service (SMS) messaging or a Wi-Fi RF transmission. In this way, by broadcasting the information, each personal communication device can be made aware of the available content, event updates, and announcements at about the same time.

In the described embodiments, the signal received at the personal communication device can include information other than the available content, event updates, and announcements. Such information can include any personal communication device identifiers, or PCDIDs, indicating the identity of those personal communication devices that have already received the information. In this way, a personal communication device can retrieve not only information related to the available content, event updates, and announcements, but other information related to those personal communication devices participating in the multifaceted event. One of the features of the PCDID is the ability to facilitate social networking within the group. In any case, the unique identifier (including any personalized information associated therewith) can be associated with the PCDID of the personal communication device and be passed between various other personal communication devices. In this way, a dynamic social network can be formed independent of or in conjunction with the available content, event updates, and announcements.

In addition to available content, event updates, and announcements, and any PCDIDs used to identity personal communication devices, the information (or the token for that matter) can include other information such as a time counter used to specify a start time and a stop time for a particular music session.

The menu of available content can be used to select audio content, event updates, and announcements stored or cached on each of the personal communication devices. The selection of available content, event updates, and announcements can be carried out in any number of different ways. For example, one of the ancillary services provided by the communication application can include categorizing content and/or stored on the personal communication device based upon various values of a particular music characteristic or content previously cached or individual identifications of participants. The communication application can create an alert to the presence of other participants selected on the basis of a specified criteria to facilitate ad hoc social networking connection. The criteria may be “fiends” or “contacts” within a certain distance. The criteria may also be based on common interests or other factors or information accessible to the system. The selected information may be prepared for private playing to a user of the personal communication device by way of a private listening accessory, such as headphones. In one embodiment, the music item(s) selected can be added to a playlist for private playing. The playlist can be presented for viewing on the personal communication device and in some cases, made available to the user for manual selection of specific content or connections. It should be noted that the individuals selected can be prequalified according to a specified criterion.

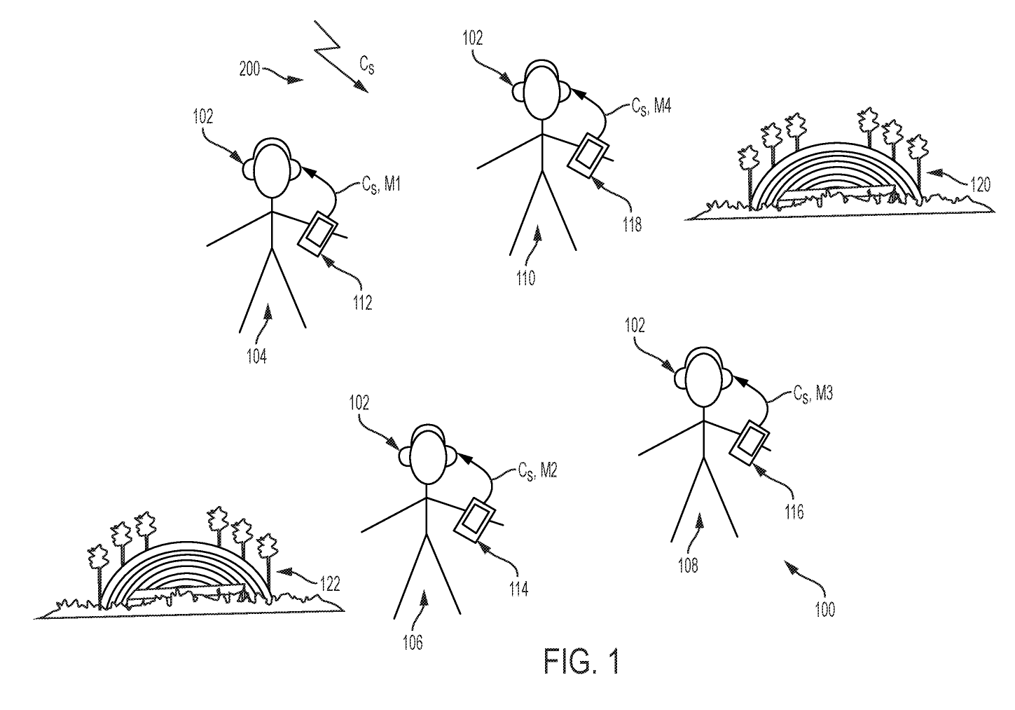

These and other embodiments of an environment where the lighting subsystem may be deployed are discussed below with reference to FIGS. 1-3. However, those skilled in the art will readily appreciate that the detailed description given herein with respect to these figures is for explanatory purposes only and should not be construed as limiting.

FIG. 1 shows group 100 participating in a multifaceted event. Along the lines of a music festival, group 100 can congregate at the event. The congregating can occur in separated areas, for example, at a first stage 120, a second stage 122, a food court exhibition area, etc. The participants can each be apprised of event updates by, for example, SMS messaging, emails (similar to a silent disco), instant messages, or a dedicated communication app such as the aforementioned audio communication or preferred audio systems. An event update might be an announcement that a particular act is about to perform at an identified stage. Each personal communication device (PCD) can privately play content for the associated member of group 100. The member can select the content it will receive. By privately playing it is meant that only the member in possession of the personal communication device can hear the privately played content. This audio privacy can be accomplished using private listening accessory 102 along the lines of a head phone, ear bud, and so on. The members may be listening to the same content broadcast, or listening to customized and/or selected content. The lighting display may be correlated to the selected content.

FIG. 1 shows group 100 participating in a multifaceted event. Along the lines of a music festival, group 100 can congregate at the event. The congregating can occur in separated areas, for example, at a first stage 120, a second stage 122, a food court exhibition area, etc. The participants can each be apprised of event updates by, for example, SMS messaging, emails (similar to a silent disco), instant messages, or a dedicated communication app such as the aforementioned audio communication or preferred audio systems. An event update might be an announcement that a particular act is about to perform at an identified stage. Each personal communication device (PCD) can privately play content for the associated member of group 100. The member can select the content it will receive. By privately playing it is meant that only the member in possession of the personal communication device can hear the privately played content. This audio privacy can be accomplished using private listening accessory 102 along the lines of a head phone, ear bud, and so on. The members may be listening to the same content broadcast, or listening to customized and/or selected content.

In order to participate in the multifaceted event communications, each of PCD 114-PCD 118 must include communications infrastructure and a control interface to select and play appropriate content. In order to assure that each of the personal communication devices in group 100 has access to the content, a communication application (not shown) can be provided and stored on each of the personal communication devices. In one embodiment, the communication application can be part of an operating system provided upon the original purchase of a personal communication device. Alternatively, the communication application can be obtained after-market using, for example, remote media management services along the lines of iTunes. On the other hand, the communication application can be obtained in an ad hoc manner during, for example, an initial invitation session whereby part of an individual acceptance of an invitation to participate in the shared music session (using email, SMS messaging, Facebook, and so on) involves downloading and installing the communication application with a subsequent verification and acceptance.

In some cases, the system may communicate over an ad hoc P2P network, or by direct by broadcast 200 communications. It should be noted that broadcast 200 can take the form of a wireless RF transmission using any number and combination of available wireless protocols. For example, broadcast 200 can take the form of conventional over the air (OTA) AM or FM broadcast in which case the user can be instructed to manually input the appropriate tuning instruction to their respective personal communication device. Alternatively, broadcast 200 can take the form of a Wi-Fi or Bluetooth RF signal that the communication application can recognize as including the updated music characteristic information.

If the system utilizes an ad hoc P2P network a limited number of members of group 100 (referred to as initiators) can be identified to seed the P2P network with announcements or a menu of available content. For a more detailed description of the heuristics of distributing information in an ad hoc P2P network please refer to “On Disseminating Information Reliably Without Broadcasting”, Proc. 7th Int. Conf. on Distributed Computing Systems (ICDCS-7), pp. 74-81 Berlin, September 1987 by Alon, N., Barak, A. and Manber, U and “An Asynchronous Algorithm for Scattering Information Between the Active Nodes of a Multicomputer System”, Journal of Parallel and Distributed Computing, Vol. 3, No. 3, pp. 344-351, September 1986 by Drezner, Z. and Barak each incorporated by reference in their entireties. Assuming that member 106 has been designated as an initiator, member 106 can seed ad hoc P2P network 302 with the event information. Member 106 may be replaced by an initiation server acting as a control station.

It is foreseeable that due to local conditions, it may not be possible to reliably send information from one node directly to another node in P2P network. For example, PCD 114 belonging to member 106 (initiator) can broadcast token T that can be received by PCD 112 and PCD 116 belonging to members 104 and 108, respectively. However, member 110 may be too far away or may be in an area (such as behind a wall) where direct reception by PCD 118 is unlikely. Therefore, each node of network can be instructed to retransmit the information wirelessly upon receiving information wirelessly. For example, when PCD 116 (as well as PCD 112) wirelessly receives the event information each can generate re-broadcast a signal that includes the event information received from member 106. In this way, PCD 118 can receive re-broadcast content information from PCD 116 (as well as that from PCD 112).

In some cases, a multifaceted event can have session rules. The session rules can define various relationships and actions that can occur between the members of the group during a specific session. For example, the session rules can provide criteria for identifying networking proposals for individual members to connect during the session. In this way, by setting the session networking rules individual members can be identified to each other and establish social networking communications, for example, as described in U.S. patent application Ser. No. 14/827,315 filed Aug. 15, 2015, entitled “Communication system for establishing and providing preferred audio,” the disclosure of which is expressly incorporated by reference herein.

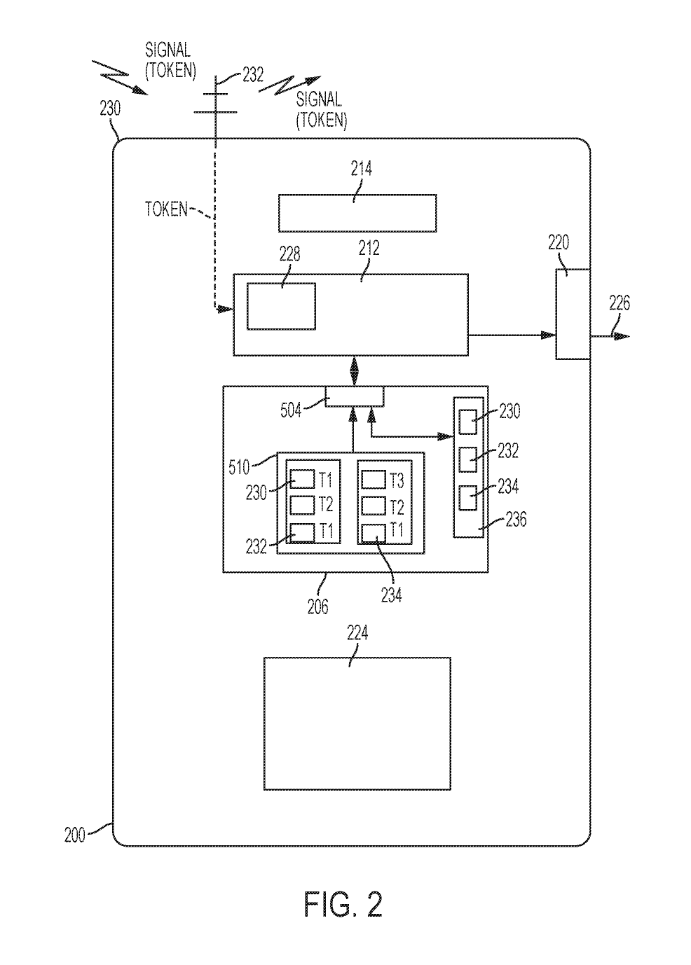

FIG. 2 shows a block diagram of a representative personal communication device (PCD) 200 in accordance with the described embodiments. PCD 200 can be formed to include at least housing 202 configured to enclose and support various operational circuits. In some cases, PCD 200 can include controller 504 used to control data storage device 206 that can be used for storing a plurality of data files that can take the form of, for example, audio data, textual data, graphical data, image data, video data and multimedia data. The stored data files can be encoded either before or after being stored using a variety of compression algorithms. It should be noted that a user can interact with manager 212 through an interface. For example, audio content can be compressed using MP3, AAC and Apple Lossless compression protocols. Other data may be compressed using protocols appropriate to such data. The audio content can include, for example, auxiliary content files 208 stored in memory 510 controlled by the content manager 212. Content manager 212 can be embodied as software executed by processor 214 or as a separate hardware component. In any case, content manager 212 can control the audio output of content files 208 stored in memory 510. The content may also include available content menus, in audio or graphic form as well as social networking criteria and/or identification.

During operation, for example, content manager 212 can select content item 216 from auxiliary content 208 which can be decoded using an appropriate codec. The decoded content file can then by output as audio signal 218 to audio output interface 220. In accordance with one embodiment, content manager 212 can select content items 216 identified by a user through a guide or by voice command. Furthermore content manager 212 may receive transmission of content and play such content substantially in real time, subject to loading, buffering and decoding delays and subject to any user control such as pause or rewind or replay.

Content may include a tag 222 to identify content type or other characteristic of the auxiliary content. For example, in a music festival the tag may indicate that the content is a commercial advertisement or offer. The tag may indicate information regarding purchase of the content, or may identify the facet of the multifaceted event that the content relates to. For example, the tag may indicate that the content relates to a performance on stage.

User input interface 224 can assist a user of PCD 200 in controlling various functions performed by PCD 200. For example, user interface 224 can include a touch sensitive layer (not shown) that can facilitate the use of a user touch event for inputting control instructions or the user interface may be an audio interface for voice commands. In the case where PCD 200 includes speakers, then audio signal 218 can be broadcast to the external environment via the speakers. However, in those situations where PCD 200 does not include speakers, or the speakers can be bypassed, PCD 200 can include private listening interface 226 suitable for directing audio signal 218 to an external transducer associated with a personal listening accessory, such as earphones, ear buds, and so on. The personal/listening device may also include a microphone for detecting and sensing audio. In this way, the user of PCD 200 can privately listen to audio output by music manager 212. PCD 200 can also include wireless interface 228 arranged to both receive and transmit information by way of any suitable wireless protocol such as, for example, Wi-Fi, Bluetooth, and so on capable of accessing various configurations of wireless networks, such as WLAN or peer to peer (P2P). It should be noted that even though only a limited set of components are shown this does not imply a limitation on the functional components that can be included in PCD 200. For example, in addition to the components shown in FIG. 5, embodiments of PCD 200 can also include a power connector, a data transfer component, voice recognition circuits, and so on.

Content manager 212 can customize the audio experience of the user. The audio may be processed to enhance and/or mask aspects of the audio to be delivered to the user, for example, in accordance with the techniques described in co-pending patent application Ser. No. 14/561,972 (111001), Ser. No. 14/827,315 (111003), Ser. No. 14/827,316 (111004), Ser. No. 14/827,320 (111009), and (111018).

In another implementation, content manager 212 can control social networking functionality. Selective networking may be provided by identifying participants in the event that satisfy a selection criteria. The system may allow a user the option of establishing networking communications with other participants who satisfy the selection criteria and designated by one or both users.

A communication application 228 can provide instructions executable by processor 214 for controlling the operations of PCD 200. In the described embodiment, the communication application can be downloaded from an online data store automatically or as a result of a user selection at user interface 224 from a central media management application (such as iTunes™) or from Apps Store maintained by Apple Inc. Alternatively, communication application 228 can be present at the time of original purchase. In any case, communication application 228 maintains a connection table to be periodically updated. The updating can occur, for example, during a synchronization operation performed between PCD 200 and a central media management application (such as iTunes™). The updating can also occur on an ad hoc basis.

Communication application 228 can provide a mechanism by which a user of PCD 200 can participate in a social networking experience provided that a connection between two users satisfies a criteria identifying a suggested connection. In addition to providing services required for participation in the social networking experience, communication application 228 can provide PCD 200 with at least the appropriate network protocols required to exchange information with other personal communication devices in a P2P network. In addition to providing the requisite communication protocols, communication application 228 can provide services related to categorizing music items stored on PCD 200 based upon various values of a particular music characteristic. The selection and networking function can be based in or distributed among PCDs or be server based. In a server-based system, the server may be local (logically) to the multifaceted event or remote such as a server connected through a wide area network including, without limitation, the Internet.

In any case, PCD 200 can obtain a connection token T by way of RF transmission 230. It should be noted that if PCD 200 is a node in a P2P network, RF transmission 230 can originate from another personal communication device within the network. In this situation, upon receiving token T, PCD 200 can generate re-broadcast signal 232 that includes at least token T while storing only tokens designated for that user. In this way, other personal communication devices with the P2P network can receive connection tokens applicable to other devices. Tokens can be transmitted by way of RF transmission 230 that originates from a central broadcaster unit. It is also possible that PCD 200 does not have wireless capabilities, in which case the token T can be provided by the communication application 228. In this way, a more limited session can be held since only those personal communication devices that have the same version of communication application 228 can participate. For example, in order to participate, PCD 200 may require the latest version of token T which can be obtained during, for example, a synchronization operation performed between the personal communication device and a central media management application.

Once token T has been received, processor 214 can determine if token T has an indication of supplemental content. For example, token T can indicate availability of content which might be background information, coupon or commercial offers, or schedules. In this case, the user may have the option to listen to the supplemental content which may be requested or accessed and can be privately played by PCD 200. Accordingly content 230, 232, and 234 each tagged as an ID that corresponds to token t1 may be accessed. In the described embodiment, a content venue 236 can be visually displayed at interface 224.

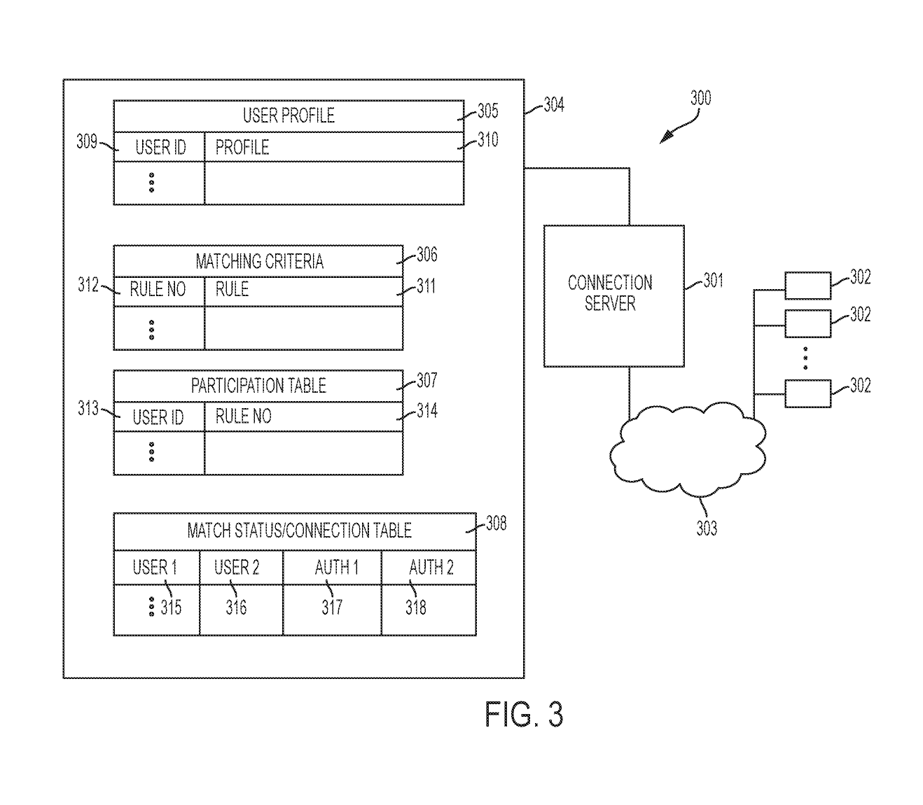

FIG. 3 shows an event-centric networking matching system 300. The system includes a connection server 301 connected to a plurality of user personal communication devices 302 by a network 303. The personal communication devices 302 may have an interface for users to control, provide instructions, and provide information to the system. Alternatively the instruction and information interface may be a separate terminal also connected to the network 303. The network 303 may be a wired or wireless local area network or wide area network. The connections may be by Bluetooth, peer-to-peer connections, small cell LTE or any other connection mechanism. The system is not specific to a particular network. The communication server 301 may be connected to data storer 304.

FIG. 3 illustrates a single data storer 304 in the form of a database management system however individual tables or distributed tables may be utilized. The data may be distributed among the users 302 or centrally located. The data may include user profile data 305 composed of a user ID 309 associated with a profile 310. The profile may include any information used by the system related to the user, for example, user name, password, gender, musical tastes, playlist, age, geographic location and any other demographic information. The system may also include a matching criteria table 306. The criteria table may include a plurality of rules 311, each associated with a rule number 312. In addition, the system may include a participation table 307 which includes a user ID 313 as an index and a rule number 314 correlating to rule numbers 312 of the matching criteria table 306. The participation table 307 includes a list of user IDs correlated to the rule numbers and the matching criteria table 306 includes those rule numbers correlated to matching criteria. Each user may be subscribed to one or more of the criteria as indicated by entries in the participation table 307. The matching criteria may include one or more requirements such as an identification of an event, a location service matching criteria, demographic matching criteria, a flag indicating appearance in a contact or approved list, and other criteria. In the example of a multi-faceted event such as a concert festival, the system may first identify all users who are participating in the event, i.e. are attending the music festival. This may be accomplished by determining which users have purchased tickets or have a token on their PCD indicating they have been admitted to the event. Alternatively, participation may be determined by location services. Each user may establish or subscribe to criteria which, if satisfied, suggests a connection. A matched status connection table 308 may be established in order to identify connections approved in accordance with the proper operation of the system. The system may go through each entry in participation table 307. For each entry the rule corresponding to the user ID may be utilized to evaluate all of the entries in the user profile table. When an entry in the user profile table satisfies a user ID rule designation, an entry may be placed in the matched status connection table 308 of the user ID in the user 1 field 315. The ID of the user who satisfied the criteria may be placed in user 2 field 316. The system may use different logic or sequences, but the idea is to create a table which has an entry for each pair of users who both satisfy the other's designated criteria. The designated criteria may be customized by each user and/or established by the system. An additional feature may permit each participant in a connection to approve or deny access even though the established criteria have been satisfied. Alternatively, one of the criteria may be approval of the matching user.

The system may also be able to establish communication groups so that connections may be one-to-many or even one-to-all. This may be established by user ID corresponding to a group criteria and each individual user who matches the group criteria is connected in the group. The system may impose an artificial limitation of allowing participation in only a single group.

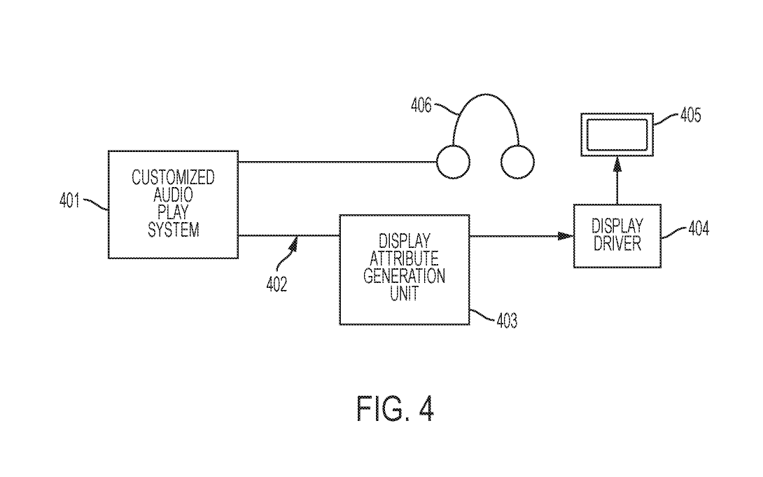

FIG. 4 shows an audio play system 401. The audio play system 401 has an output representative of one or more aspects of the audio selection. A display attribute generation unit 403 may be provided and is responsive to the signal representative of content 402. The customized audio play system 401 may be connected to personal audio speakers 406. The personal audio speakers 406 may be headphones, earphones, or any other device for converting electrical signals to audio.

The display 405 may constitute one or more light elements. The light elements may be LED light elements or any other light emitting element. The display 405 may be monochrome or controllable to vary the color, intensity, and image of the lighting output. The display 405 may have one or more color points such as the Pixmob or Xyloband displays. The display 405 may be suitable to display image or video. The display 405 may be mounted on a headphone or may be wearable in some other fashion, although it is not necessary for the display 405 to be mounted on or even co-located with a user. The signal representative of content 402 must be derived in part from the operational parameters of the customized audio play system. While the display 405 may in part be controlled by audio intensity in the fashion of a light organ, the signal representative of content must include, in part, a signal representative of operating parameters. The operating parameters may include audio source selection, non-audio control signals, user-selected parameters, system-selected parameters, content-type parameters or other non-audio parameters.

A display attribute generation unit 403 may be provided to generate signals to be displayed. Those signals may be provided to the display driver 404.

As an example, the light display system might be utilized in connection with a system shown in FIGS. 1-3 for a multi-stage concert event. In such a multi-stage concert event, each user may customize the audio being provided to a headphone by selection of one stage to be included in the user's customized audio. The light attribute to be displayed will in some way correspond the selected stage. For example, a country music stage may be designated by the color red, a rock and roll stage may be designated by the color white, and a techno stage may be designated by blue. When a user selects which stage to include in a customized audio feed, the display 405 may be illuminated with the corresponding color.

The invention is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention. For the sake of clarity, D/A and ND conversions and specification of hardware or software driven processing may not be specified if it is well understood by those of ordinary skill in the art. The scope of the disclosures should be understood to include analog processing and/or digital processing and hardware and/or software driven components

Thus, specific apparatus for and methods of a customized audio display system have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A personalized lighting display system comprising:
a personalized audio play device;
a display attribute generation unit connected to said personalized audio play device;
a display driver responsive to said display attribute generation system; and
a lighting display connected to said display driver.

2. A personalized lighting display system according to claim 1 wherein said lighting display is a monochrome display.

3. A personalized lighting display system according to claim 1 wherein said lighting display is a multi-colored display.

4. A personalized lighting display system according to claim 3 wherein said multi-colored display further comprises LEDs.

5. A personalized lighting display system according to claim 1 wherein said display attribute generation unit is responsive to an operating parameter of said personalized audio play device.

6. A personalized lighting display system according to claim 5 wherein said operating parameter is identification of content.

7. A personalized lighting display system according to claim 5 wherein said operating parameter is an attribute contained in a user profile.

8. A personalized lighting display system according to claim 5 wherein said operating parameter is set by a user.

9. A personalized lighting display system according to 1 wherein said lighting display is an illuminating element integrated into a personal speaker device.

10. A personalized lighting display system according to claim 9 wherein said personal speaker system is headphones.

11. A personalized lighting display system according to claim 9 wherein said lighting element is integrated into a headband of said headphones.

12. A personalized lighting display system according to claim 10 wherein said lighting element is integrated into earphone shells of said headphones.
